(19) United States
(12) Patent Application Publication
(10) Pub. No.: US 2003/0233534 A1
(43) Pub. Date: Dec. 18, 2003

(54) Enhanced computer start-up methods

(76) Inventors: Adrian Bernhard, Friedberg (DE); Manfred Federle, Klosterlechfeld (DE)

Correspondence Address: Snell & Wilmer LLP, One Arizona Center, 400 E. Van Buren, Phoenix, AZ, 85004-2202, US

(21) Appl. No.: 10/167,835

(22) Filed: Jun. 12, 2002

(51) Int. Cl. G06F 9/00

(52) U.S. Cl. 713/1

(57) ABSTRACT

Methods for facilitating the rapid startup or booting of a computer system is disclosed. Configuration data for a computer system may be collected and stored in nonvolatile memory. The collection of configuration data may be performed by a computer program that is stored on an external computer medium. The configuration data may include device data for the various hardware devices and memory that is typically identified and configured by a standard BIOS program. The collected configuration data may be stored in nonvolatile memory. Upon a power on or reset event, the configuration data may be read from nonvolatile memory and written directly to memory and the various hardware devices. After the configuration data is written to the various devices, the normal boot sequence of loading and executing the operating system may be resumed.

### TECHNICAL FIELD

The present invention generally relates to booting computer systems. More specifically, the present invention relates to the rapid booting of a computer system such that near-continuous operation of the computer system may be achieved.

### BACKGROUND INFORMATION

When a personal computer (PC) system is booted, the Basic Input Output System (BIOS) program resident in the system determines the hardware configuration and sets up chip registers in various hardware devices so that the operating system will run correctly. The hardware devices that need to be configured may include components such as interrupt handling devices, small computer system interface (SCSI) devices, IDE memory devices, video components, direct memory access (DMA) controllers, bus bridges, memory controllers, and caches. Once set up, the BIOS loads and activates the operating system. The BIOS does not repeat the configuration process unless the system is rebooted.

The time spent by the BIOS determining the configuration and setting up the computer system can be significant—twenty seconds or more. The amount of time is necessary because there are many aspects of the PC architecture that cannot be coded into either the BIOS or the operating system ahead of time. In addition, desktop PCs are often reconfigured by adding or removing boards and other devices. Thus, it is necessary for the computer system to determine its configuration each time it is booted.

In certain applications, the amount of time spent by the booting process is unacceptable. For example, if the PC is embedded inside a system that controls manufacturing equipment, communications gear, or vehicles, the loss of control for such a long period of time could result in catastrophic loss of information, service, property, or even in loss of life. A delay of approximately one second would be acceptable in many of these cases.

A computer system includes many different hardware components such as the processor, chipset, memory devices, video devices, input/output devices and the like. These components have the common requirement for initialization due to the fact that the components lose their programmed configuration after a power off or reset. The initialization is done by writing configuration data to certain registers or memory addresses. The BIOS (Basic Input Output System) is responsible for this initialization, however, the closed nature of the BIOS program prevents PC users from modifying the BIOS program.

A typical computer system can be modified by the user. The memory can be upgraded to a greater size, the processor can be changed to a faster one or an add-on card with new functionality can be added to the system. Since it is not user-friendly to have a different BIOS code for all possible combinations, there is one common BIOS that is able to handle all configurations. But that requires the BIOS to initiate an identification process in order to determine the correct initialization.

For example, in order to detect the size and amount of main memory, the size of main memory is counted once after power on by writing and reading all possible memory addresses until there is a failure. The resulting size will then be programmed in the corresponding chipset registers.

In a simplified description, a typical power on procedure will include a power on/reset step, identification of various hardware devices such as the central processing unit (CPU), memory devices, plug and play (PnP) devices and the like, initialization (i.e., configuration) of the various devices, and finally, loading and starting up the operating system (OS).

One disadvantage of this flexible solution is the amount of time required to go through identification and initialization of the various hardware devices after each power on or reset. This process can be in the range of 30 seconds or more, which is often unacceptable to users of embedded systems.

One technique used by present computer systems for a quick configuration utilizes the well-known “Suspend Mode.” A PC that supports Suspend Mode copies the configuration data for the various hardware devices including memory to secondary storage (disk file) upon the user's command. The PC will then turns itself off, typically to save power and extend battery life. When the PC is turned on again, the disk file is loaded into memory, the configuration restored, and the PC starts up from where it left off when Suspend Mode was entered, without the need to again boot the PC.

This technique of utilizing the Suspend Mode circumvents the BIOS configuration check, however, this technique can only be used following the orderly shutdown or “suspension” of the computer system. There still exists a need to rapidly start up a computer system following unpredictable system failures that currently require a time consuming reboot.

### SUMMARY OF THE INVENTION

The present invention provides methods for facilitating the rapid start-up or booting of a computer system. In accordance with one aspect of the present invention, device data (i.e., configuration data) is collected for a plurality of hardware devices for a computer system that is booted using a standard BIOS program. The device data may be written to nonvolatile memory, such as flash memory. Alternatively, the device data may be stored on an external computer readable medium such as a floppy disk and later written to nonvolatile memory. Upon a power on or reset event, the configuration data for the computer may be read from the nonvolatile memory and written to the plurality of devices. The step of loading an operating system into random access memory may then take place.

In accordance with another aspect of the present invention, the configuration data for the computer may comprise register data and memory data. The register data may be written directly to the appropriate registers for the plurality of hardware devices and the memory data may be written to the appropriate locations in main and/or secondary memory.

In accordance with another aspect of the present invention, the step of collecting the device data and the step of writing the device data to the nonvolatile memory may be performed exactly once and may be performed during manufacture of the computer. In addition, the step of collecting the device data may be performed by a computer program that is stored on an external computer readable medium such as a floppy disk or CD.

In accordance with another aspect of the present invention, a quick BIOS program may be created that reads the configuration data from nonvolatile memory and writes the configuration data to the appropriate devices and memory locations.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 illustrates a block diagram of a computer system used with an embodiment of the present invention;

FIG. 2 illustrates a flow chart of an exemplary process for collecting and storing configuration data in accordance with the present invention; and

FIG. 3 illustrates a flow chart of an exemplary computer start up process in accordance with the present invention.

### DETAILED DESCRIPTION

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

It will be appreciated, that many applications of the present invention could be formulated. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a computer system, a device for booting a computer system, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

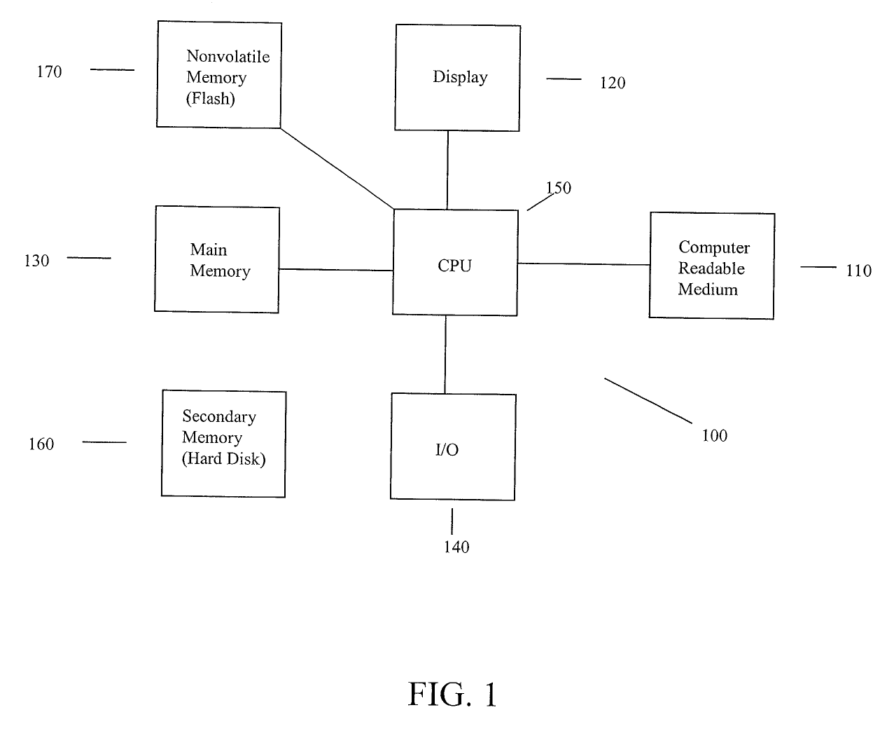

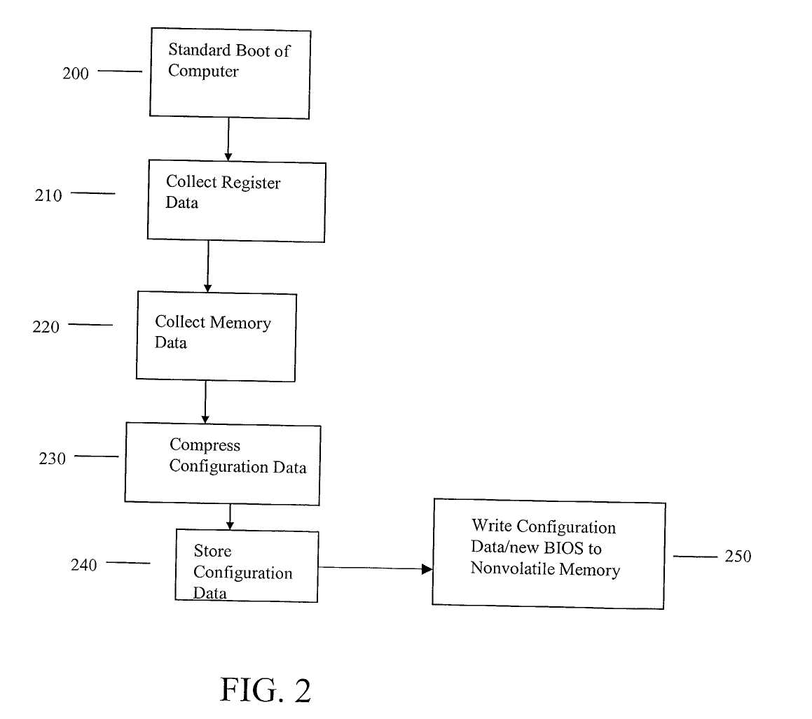

FIG. 2 is a flow diagram that depicts the operation of one embodiment of the present invention. The technique shown in FIG. 2 can be implemented as computer software in the form of computer readable program code executed on a general purpose computer such as computer 100 illustrated in FIG. 1. A central processing unit (CPU) 150 is coupled to a computer readable medium device 110, a display 120, a main memory 130, I/O devices 140, secondary memory devices 160, and nonvolatile memory 170. Display 120 may comprise various types of displays with different form factors, such as personal computer displays, mobile phone displays, laptop computer displays, and the displays of other consumer electronic and portable devices. I/O devices 140 represent such input/output devices as a keyboard, a mouse, a printer, A/V (audio/video) I/O, and the like. Computer readable medium device 110 represents devices for handling various forms of computer readable medium such as CDROM, DVD, diskettes, removable hard drives, and the like. Secondary memory devices 160 include storage devices such as a hard disk. Nonvolatile memory 170 may include a nonvolatile memory such as flash memory that can hold its memory content without power. Processor 150 is a processor with a sufficient amount of processing power to execute a software program that embodies the technique summarized in FIG. 2. CPU 150 may comprise a processing unit that provides the CPU functions for a computer, that is, the CPU includes the microprocessor that controls the computer and also includes the chipset that allows the microprocessor to interface with various peripherals. Processor may include any of a variety of commercially available processors such as AMD 29K, Power PC, x86 type processors (e.g., Pentium II), and the like. As discussed in greater detail below, the technique summarized in FIG. 2 performs the rapid initialization and configuration of a computer system.

With reference to FIG. 2, configuration data for a computer may be collected and stored such that it may be later accessed by a boot-up method in accordance with the present invention. Configuration data for a computer may include, but not be limited to, device data for a plurality of hardware devices such as I/O devices 140, display devices 120, computer readable medium devices 110, main memory 130, and secondary memory devices 160. Stated another way, the hardware devices that may be configured include interrupt handling devices, small computer system interface (SCSI) devices, IDE memory devices, video components, direct memory access (DMA) controllers, bus bridges, memory controllers, caches, and the like.

The device data may include information such as register data for the registers associated with the plurality of hardware devices. In addition, configuration data for a computer may also include memory data for main memory 130 and secondary memory 160 such as the size of the memory or the number of partitions of the hard disk. Stated another way, configuration data includes any information that is used to identify and configure hardware devices and memory such as resource usage data. It should be appreciated that the configuration data may include any information about the computer that is identified or otherwise detected by a typical BIOS program used in booting a computer system.

With reference to FIG. 2, a single representative computer may be booted once by the manufacturer or other user and the computer's configuration may be read out and stored externally. The computer's configuration data may be read from the various devices. Alternatively, the configuration data may be determined by various other techniques such as sampling with a logic analyzer, emulator, source code analyzing, and any other technique that can be used to determine the computer's configuration data. Source code analyzing may include examining the source code of the original BIOS program and analyzing what data is written to various devices. For example, source code analyzing may be used to determine the value of data written to write-only registers of a particular device. The configuration data may then be combined with the rest of the BIOS into a program that can write the configuration data directly to the hardware devices that need the data at boot time and then load and start the operating system. This process will now be described in more detail.

The computer is first booted by utilizing the standard BIOS program (200). After the identification and initialization is performed by the standard BIOS, configuration data may be collected for the various hardware components. The collection of the configuration data may be performed by a special software program that is executed from a computer readable medium such as a floppy disk, CD, DVD, removable hard drive and the like. Alternatively, the collection of the configuration data may be performed by a software program that is executed from the hard drive of the computer. In accordance with another aspect of the present invention, the software program may be executed on an external computer system that is connected to the computer for which the configuration data is being collected.

The configuration data may include register values and may also include several megabytes of memory data. In accordance with one aspect of the present invention, the collection of configuration data may include collecting register data (210) and memory data (220) from all hardware components. Together with the location (register or memory index), the configuration data may be stored on a computer readable medium such a floppy disk (240). To save space, the memory data and/or the register data may be optionally compressed by an adequate algorithm (230). The memory data may include data from any type of memory such as flash memory, SRAM, DRAM, and the like. Furthermore, the memory data and the register data may include any data that is necessary to properly initialize the computer.

The collected configuration data may be combined with initialization code that forms a new BIOS image. The new BIOS image may be prepared such that it may be burned into nonvolatile (i.e., flash) memory with a standard Flash programming tool (250). The previous standard BIOS can then be replaced by this new code. This step may take place as part of the manufacturing process, or at any time prior to or during use of the computer system.

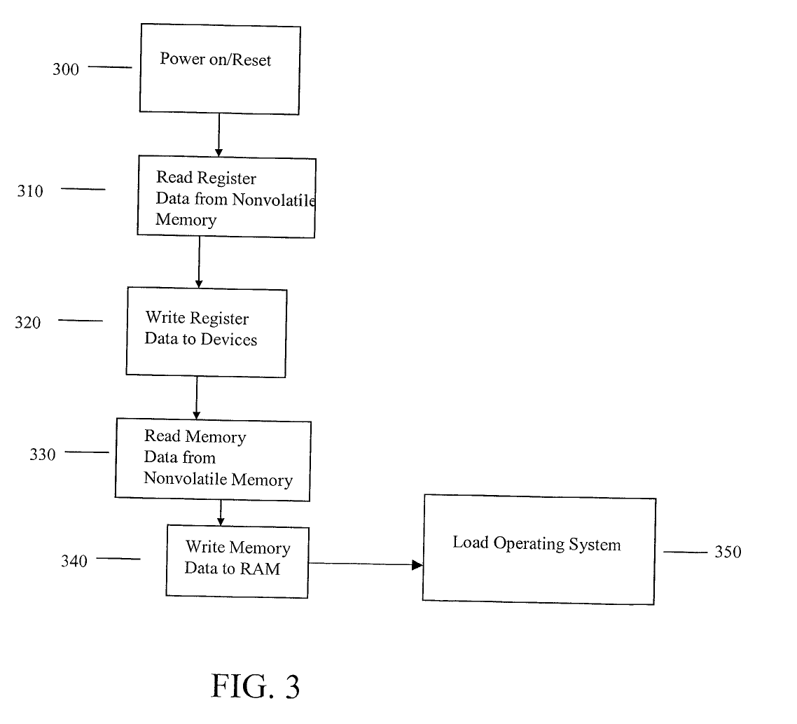

With reference to FIG. 3, the computer system may be loaded (typically into Flash memory) with this new version of the BIOS that takes the previously-determined configuration data and stores the data directly into the devices (i.e., chips). It will be appreciated that this process of directly loading the configuration data circumvents the time-consuming discovery process previously required for every boot.

In accordance with one aspect of the present invention, upon a power on/reset event (300), the new version of the BIOS may be used to boot computer 100. The quick boot process may be initiated by reading the previously stored configuration data from nonvolatile memory. As stated above, the configuration data may include register data and memory data. The register data may be read (310) from nonvolatile memory 170 and then written out (320) to the appropriate hardware devices. In addition, the memory data may be read (330) from nonvolatile memory 170 and written out (340) to the appropriate locations in main memory 130 and/or secondary memory 160. Finally, the operating system may be loaded and initiated (350).

Stated another way, after a power on or reset event, the loader starts the new BIOS program at its predefined location. The configuration data will be read from nonvolatile memory for all registers and memory locations. This configuration process may be performed rapidly as the configuration data is stored in flash memory and there is no need to identify and detect various hardware devices. The boot loader will then continue with reading the operating system.

The new BIOS image can be used for any computer system with similar hardware settings to the computer system that was used to build the new BIOS image.

It will be appreciated that the present invention provides for methods and system that greatly reduce the amount of time needed to boot a computer system. For example, in accordance with one embodiment of the present invention, a computer system may be booted in less than two seconds. Furthermore, in accordance with one aspect of the present invention, the configuration process is entirely omitted from the boot process which contributes to the reduction in boot time.

It will also be appreciated that the present invention is particularly suited for applications where the computer configuration typically remains unchanged for a long period of time. For example, computers used by embedded systems, unlike desktop computers, are shipped in only a few different configurations. Each customer typically receives a large number of identically-configured computers. These computers may then be used by customers in other larger systems where the modification of the computer's configuration is physically prevented from occurring. In these types of applications where the configuration of computers is unchanged for large periods of time, there is no need for the time-consuming dynamic configuration.

The faster boot time permitted by the present invention permits the use of standard personal computers in applications where they were previously unsuited. For example, applications that previously required two or more computers to guarantee near-continuous operation, can now use only one fast-booting computer, thus saving time, weight, space, and cost.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A method of booting a computer having random access memory and nonvolatile memory, comprising the steps of:
reading configuration data for the computer from the nonvolatile memory;
writing the configuration data to a plurality of devices; and loading an operating system into the random access memory.

2. The method of claim 1, wherein:
the step of reading configuration data comprises reading device data for a plurality of devices from the nonvolatile memory; and
the step of writing the configuration data comprises writing the device data to the plurality of devices.

3. The method of claim 2, wherein:
the step of reading device data comprises:
reading register data for a plurality of registers from the nonvolatile memory; and
reading memory data from the nonvolatile memory; and
the step of writing the device data comprises:
writing the register data to the plurality of registers; and
writing the memory data to the random access memory of the computer.

4. The method of claim 3, wherein the nonvolatile memory comprises flash memory.

5. The method of claim 3, further comprising the steps of:
collecting the device data for a plurality of devices; and
writing the device data to the nonvolatile memory.

6. The method of claim 5, wherein the step of collecting the device data and the step of writing the device data to the nonvolatile memory are each performed exactly once.

7. The method of claim 6, wherein the step of collecting the device data and the step of writing the device data to the nonvolatile memory are each performed during manufacture of the computer.

8. The method of claim 5, wherein the step of collecting the device data is performed by a computer program.

9. The method of claim 8, wherein the computer program is stored on a computer readable medium.

10. The method of claim 9, further comprising the step of storing the collected device data on the computer readable medium.

11. The method of claim 10, further comprising the step of reading the collected device data from the computer readable medium.

12. The method of claim 11, further comprising the step of encrypting the collected data, and wherein:
the step of storing the collected device data comprises storing the encrypted collected device on the computer readable medium; and
the step of reading the collected device data comprises reading and decrypting the encrypted collected device data from the computer readable medium.

13. The method of claim 1, wherein the steps of the method may be executed in less than two seconds.

14. The method of claim 1, wherein the computer includes a x86 type processor.

15. A method of creating a quick BIOS program for a computer having a plurality of hardware components, comprising the steps of:
collecting configuration data for the plurality of hardware components;
writing the collected configuration data to a nonvolatile memory of the computer;
combining the collected configuration data with a first computer program that can perform the steps of:
reading the configuration data from the nonvolatile memory;
writing the configuration data to the plurality of hardware components; and
loading an operating system into a random access memory of the computer.

16. The method of claim 15, wherein:
the step of collecting configuration data comprises collecting device data for a plurality of devices;
the step of writing the collected configuration data to a nonvolatile memory comprises writing the collected device data to a nonvolatile memory of the computer;
the step of reading configuration data comprises reading the device data for the plurality of devices from the nonvolatile memory; and
the step of writing the configuration data comprises writing the device data to the plurality of devices.

17. The method of claim 16, wherein the device data comprises register data and memory data, wherein the register data is associated with a plurality of registers of the hardware components and the memory data is for memory associated with the computer.

18. The method of claim 17, wherein the nonvolatile memory comprises flash memory.

19. The method of claim 17, wherein the step of collecting the device data and the step of writing the device data to a nonvolatile memory are each performed exactly once.

20. The method of claim 19, wherein the step of collecting the device data and the step of writing the device data to a nonvolatile memory are each performed during manufacture of the computer.

21. The method of claim 17, wherein the step of collecting the device data is performed by a second computer program.

22. The method of claim 21, wherein the second computer program is stored on a computer readable medium.

23. The method of claim 22, further comprising the step of storing the collected device data on the computer readable medium.

24. The method of claim 23, further comprising the step of reading the collected device data from the computer readable medium.

25. The method of claim 24, further comprising the step of encrypting the collected data, and wherein:
the step of storing the collected device data comprises storing the encrypted collected device on the computer readable medium; and
the step of reading the collected device data comprises reading and decrypting the encrypted collected device data from the computer readable medium.

26. A method for creating a quick boot BIOS program for a computer, comprising the steps of:
executing a standard BIOS program for the computer;
collecting configuration data from a plurality of hardware components of the computer;
storing the configuration data on an external storage medium;
combining the configuration data with initialization code to form a quick boot BIOS program; and
storing the quick boot BIOS program in a nonvolatile memory of the computer.
